(19) United States
(12) Patent Application Publication
(10) Pub. No.: US 2010/0206197 A1
(43) Pub. Date: Aug. 19, 2010

(54) BITUMINOUS COMPOSITION, FABRICATION PROCESS AND USE THEREOF IN ROAD ENGINEERING

(76) Inventors: Nuria Uguet Canal, Madrid (ES); Laetitia Herrero, Carquefou (FR); Javier Aznar Hurtado, Madrid (ES); Didier Lesueur, Madrid (ES)

Correspondence Address: FOLEY AND LARDNER LLP;SUITE 500, 3000 K STREET NW, WASHINGTON, DC, 20007, US

(21) Appl. No.: 12/374,293

(22) PCT Filed: Jul. 18, 2007
(86) PCT No.: PCT/EP2007/057410

§ 371 Date: Jan. 16, 2009

(30) Foreign Application Priority Data
Jul. 19, 2006 (FR) 0606555

(51) Int. Cl. C09D 195/00; C08L 95/00

(52) U.S. Cl. 106/277

(57) ABSTRACT

The invention concerns a fabrication method of a bituminous emulsion, consisting in the use of a primary bitumen emulsion, possibly diluted, characterized by a median diameter of less than 2 μm, as aqueous phase of a secondary bitumen emulsion characterized by a median diameter of more than 2 μm, wherein the final emulsion thus obtained is characterized by a bitumen content of 50% to 95% by weight, a STV viscosity at 40 C through the 4 mm orifice of less than 300 s and a settling tendency of less than 10% as determined by means of assay EN 12847.

The invention relates to an aqueous bituminous composition which may be used in road engineering, to its fabrication method and to its use in road engineering. The composition is obtained by dispersing a primary bitumen emulsion, characterized in that its particle size is smaller than 2 μm in the aqueous phase used for making a secondary bitumen emulsion, characterized in that its particle size is larger than 2 μm, so that a final bitumen emulsion may be obtained containing up to 95% of bitumen, characterized by low viscosity so that it may be used with present methods for applying and transporting roadway bitumen emulsions.

For a better understanding of the invention, it seems to be useful to provide the following definitions:
by bitumen, is meant a roadway bitumen or any bitumen-based composition optionally containing one or more acids or bases and/or one or more emulsifiers and/or one or more viscosifiers and/or one or more fluxing agents and/or one or more plasticizers and/or any other additive with which the properties of the composition may be adjusted, except polymeric additives. Roadway bitumens are so-called natural bitumens, originating from crude oil, bituminous schists, heavy oils, bituminous sands, etc., and notably obtained by distilling and de-asphalting the heavy fraction originating from distillation. The specifications for roadway bitumens are described in the NF EN 12591 standard, “Spécifications des bitumes routiers” (Specifications of roadway bitumens), but also in the projected standard prNF EN 13924 “Spécifications des bitumes routiers durs” (Specifications of hard roadway bitumens). Are also meant bitumens modified by a polymer, i.e. bitumens containing at least one polymer and more generally any bitumen-based composition containing at least one or more polymers and/or one or more acids or bases and/or one or more emulsifiers, and/or one or more viscosifiers and/or one or more fluxing agents originating from petroleum, coal, vegetable, animal or other sources, and/or one or more plasticizers, and/or any other additive with which the properties of the composition may be adjusted. The specifications for modified bitumens are described in the projected prEN 14023 standard, “Spécifications des bitumes modifiés par des polymers” (Specifications of bitumens modified by polymers). Finally and by extension, are also meant the bitumen substitutes called “synthetic binders” or “clear binders”, which are non-bituminous products which are aimed at reproducing notably mechanical and adhesive properties of bitumens except for their black color, with which non-black roadway materials may be made, optionally colorable by introducing a pigment and/or by selecting colored granulates;
polymer means natural or synthetic polymers. This is for example a polymer from the family of elastomers, either synthetic or natural, and in an indicative but non-limiting way, random, multi-block or star copolymers of styrene and butadiene in all proportions or copolymers from a same chemical family (isoprene, natural rubber, . . . ), optionally crosslinked in situ, copolymers of vinyl acetate and ethylene in all proportions or of the same family (butyl, methyl acrylate, . . . and polyolefins). These may be recycled polymers, from e.g. fine rubber powders obtained from used tyres, from miscellaneous waste (cables, packaging, agricultural waste, . . . ) or further any other polymer currently used for modifying bitumens such as those mentioned in the technical guide written by the World Road Association (PIARC) and edited by the “Laboratoire Central des Ponts et Chaussées” “Use of Modified Bituminous Binders, Special Bitumens and Bitumens with Additives in Road Pavements” (Paris, LCPC, 1999), as well as any mixture in any proportion of these polymers;
by acid is meant for example, phosphoric acid and its derivatives, salts and esters, hydrochloric acid, sulfuric acid, acetic acid and any acid or combination of acids,
by mineral or organic filler, are meant for example clays, mineral fines, cement, lime, silica, carbon black, mineral, metal or organic fibers, in particular textile fibers;
by bitumen emulsion, is meant an aqueous dispersion of bitumen optionally containing one or more additives and/or one or more emulsifiers and/or one or more viscosifiers and/or one or more fluxing agents and/or one or more plasticizers and/or any other additive with which the properties of the emulsion may be adjusted. The emulsifier may be a surfactant and/or a solid and/or a mixture in any proportion of these products. An emulsion is defined here as being concentrated if the bitumen content is larger than 72%;
by a bituminous mix, is meant a mixture of granulates sorted by size and of a bitumen optionally comprising one or more additives, for example organic or mineral fibers, fine rubber powders, optionally derived from the recycling of used tyres, miscellaneous waste (cables, polyolefins, . . . ) as well as their mixtures in all proportions;
by granulates, are meant granulates of miscellaneous origin, among which granulates originating from quarries or gravel pits, recycled products such as aggregates from the milling of old coated materials, manufacturing scrap materials, materials from the recycling of building materials (demolition concretes, . . . ), slags, schists, artificial granulates of any origin and for example from clinkers from municipal solid waste incineration (MSWI), as well as their mixtures in all proportions. Specifications for these materials are described in the NF EN 13 043 standard dealing with “Granulats pour mélanges hydrocarbonés et pour enduits superficiels utilisés dans la construction des chaussées, aérodromes et d'autres zones de circulation” (granulates for hydrocarbon mixtures and for surface coatings used in the building of roadways, airfields and other traffic areas);
by cold coating material, is meant any mixture obtained by kneading an emulsion of bitumen and granulates, either dry or not, optionally in the presence of water added in addition to that of the emulsion and to that naturally present in the granulates, and of additives which may be the same as those generally used in bituminous coating materials, but also more specific additives notably aiming at controlling the breaking of the emulsion, such as for example emulsion breakers which may be for example selected from acids or bases, mineral additives such as hydraulic cement (Portland cement, pozzolans, Sorel cements, . . . ), lime, or mineral salts as well as setting retarders which may also be mineral salts or organic compounds such as for example acids, bases or surfactants, agents such as salts or their acid from phosphates, phosphonates and phosphinates and/or mineral and/or organic polyphosphates. Said cold mixes may for example be obtained by mixing a bitumen emulsion and a moist or dry granulate in various proportions. Generally, with mixing, it is possible to finally obtain between 0.1 and 30 parts by mass of bitumen for 100 parts of dry granulate (i.e. 0.1-30 parts per hundred, noted as pph) and preferentially between 2 and 15 pph depending on the applications. Exemplary cold mixes well-known to one skilled in the art are cold-cast mixes, bituminous slurry seals, emulsion-stabilized gravels, cold dense mixes, cold open mixes, products from old roadways with bitumen emulsion, re-treated or recycled on site or in a plant, or further cold bituminous concretes;
by surface coating, is meant any mixture which aims at finally obtaining a surface layer containing granulates embedded in a bitumen as a thin layer, as described in the Technical Guide “Enduits Superficiels d'Usure” (wear-surface dressings) published by the “Service d'Etudes Techniques des Routes et Autoroutes (SETRA) an the “Laboratoire Central des Ponts et Chaussées (LCPC) in may 1995. In particular, bitumen emulsions may advantageously be used for this type of application.

The bitumen emulsions generally include between 50 and 72% by mass of bitumen which may possibly contain one or more additives and a supplement often called “an aqueous phase” which may optionally contain one or more emulsifiers and/or additives.

Bitumen is present in the emulsion as fine droplets, the particle size of which may be easily measured by various experimental techniques described in the book edited by P. Becher “Encyclopedia of emulsion technology”, Vol. 1 (Marcel Dekker, New York, 1983), the most used technique probably being diffraction of light applied by devices known as “laser granulometers” and marketed for example by Malvern or Coulter. The particle size is often expressed as a median volume diameter, noted as d₅₀, which represents the diameter for which 50% (by volume) of the particles of the emulsion have a diameter larger (or equivalently smaller) than this value.

Bitumen emulsions are obtained by fragmentation of the bituminous binder in the presence of the aqueous phase in suitable devices which may be continuous devices such as colloidal mills or static mixers, or discontinuous devices such as certain so-called phase inversion methods under conditions of concentrates.

The aqueous phase may also contain additives, in particular emulsifiers, bases and/or acids with which for example the pH thereof may be adjusted, salts, but also viscosifiers or even emulsions of non-bituminous products, such as for example natural or synthetic lattices. In the manufacturing step, the role of the emulsifier, which may be a mixture of different products, is to promote formation of bitumen drops and to stabilize them, thereby allowing the emulsion to survive. Although this is not always strictly necessary, some bitumens may be emulsified without additives; the emulsifier is nearly always used and is generally placed in the aqueous phase, even if it may also be provided entirely or partially in the bitumen phase.

Accordingly, the bitumen emulsions are generally characterized by the type of emulsifier used for maintaining the bitumen in dispersion. Cationic emulsions are known, i.e. obtained with an emulsifying agent including one or more ionic groups bearing a positive electric charge. These emulsifiers generally require working in an acidified medium at pHs which may usually and in a non-limiting way, attain values from 1.5 to 3. Anionic emulsions are also used, and are obtained with an emulsifying agent including one or more ionic groups bearing a negative electric charge. This generally requires working in a basic medium at pHs which may usually reach values from 10 to 12. There also are emulsions based on other types of emulsifiers, such as non-ionic or amphoteric emulsifiers, not very used in road engineering. The non-ionic emulsifiers do not have any ionic group and the amphoteric ones have both cationic and anionic groups depending on the conditions. It is also known that solid particles such as clays, colloidal silica, may emulsify the bitumen and are therefore also considered as emulsifiers. The nature and content of emulsifiers provide adjustment of the breaking rate of the emulsion and one skilled in the art knows how to formulate emulsions with a controlled, fast, slow or intermediate breaking rate, in order to satisfy current applications.

Bitumen emulsions are currently used in road engineering applications for miscellaneous applications, where they are spread either alone in order to obtain for example tack layers, impregnation layers and point repairs (“stitch in time” repair, joints, filling cracks) or in the presence of granulates in order to make surface coatings or so-called “cold” mixes. Typical applications of bitumen emulsions and the characteristics which they impose to the emulsion may for example be found in the book edited by the “Section des Fabricants d'Emulsions Routières de Bitume (SFERB) of the “Union des Syndicats de l'Industrie Routière Française” (USIRF), “Les Emulsions de Bitume” (SFERB, Paris, 1988).

In all cases, the emulsion is a vector for providing the bitumen, which should be stable when stored before its use but for which one seeks to obtain breakage when it is applied. Breakage is meant here to be the transition from an initial condition when the bitumen is dispersed as fine droplets in an aqueous phase (emulsion) to a final condition where the bitumen forms a continuous film which may for example coat the granulates. Thus, bitumen emulsions have storage stability specifications, which for example are described in the French standard of specifications for cationic emulsions (NF T 65-011).

According to the European EN 13808 standard providing a framework for specifying bitumen emulsions, the stability criteria should be given according to the EN 12847 test “Determination of settling tendency of bituminous emulsions”, and consisting of measuring the difference between the water contents of the upper layer and of the lower layer of a prescribed sample volume after having left it at rest, at room temperature for a week.

The emulsion is a vector for providing the bitumen; by reducing the water content, it is possible to limit the required emulsion volume in order to provide the given amount of bitumen required by the sought application. Also, maximization of the bitumen content is generally sought in the emulsion so as to reduce the transport costs. At the same time the consumption of water may be reduced, which represents an obvious benefit in areas where water is a resource which has to be saved. Finally, breakage of the emulsion proceeds in part with the departure of water, notably by evaporation, and, all the other parameters being otherwise constant, a concentrated emulsion may therefore break more rapidly than an emulsion having a lower bitumen content.

One of the essential properties of a bitumen emulsion is its viscosity. A too viscous emulsion cannot be handled by the equipment presently used in road engineering, in particular the pumps and spraying nozzles. Further, in applications where the emulsion is used for making a cold mix, a too viscous emulsion will not be able to coat the granulates properly. A too fluid emulsion is not always sought, either because it creates risks of run-outs during spraying or coating, or facilitates sedimentation of the bitumen drops, limiting long term stability. However, the use of bitumen emulsions for achieving impregnation of a granular support requires low viscosity so that the emulsion may penetrate within the support. Accordingly, and depending on their contemplated field of application, bitumen emulsions have viscosity specifications, which are for example described in the French standard for specifications of cationic emulsions (NF T 65-011).

According to the European standard EN 13808, giving a framework for specifying bitumen emulsions, the viscosity criteria should be provided according to the EN 12846 test “Determination of efflux time of bitumen emulsions by the efflux viscometer method”, called currently STV (Standard Tar Viscometer) viscosity and consisting of measuring the time for the emulsion to flow through a standardized device having an orifice with a diameter with 2, 4 or 10 mm, at a test temperature typically of 25, 40 or 50° C.

The control on the viscosity of the emulsion is essentially obtained by the bitumen content, even if there are additives having a viscosifying character, their high additional cost however limits industrial use. Indeed, it is well known to one skilled in the art that an emulsion with low bitumen content has a smaller viscosity than that of an emulsion with high bitumen content, which is described for example in the already mentioned book “Les Emulsions de Bitume” (SFERB, Paris, 1988).

For this reason, bitumen emulsions used nowadays in road engineering do not exceed 72% by mass of bitumen, because the making of more concentrated emulsions with the present means would involve too high viscosity which would not allow them to be used with the equipment currently used in the trade.

However, the making of concentrated bitumen emulsions of more than 72% remains possible. Thus, patent EP 0 162 591 belonging to BP and Intevep describes the making by a batch method of emulsions having between 70% and 98% of bitumen. Also, patent EP 0 999 890 belonging to the CNRS describes the making by a batch method of emulsions having between 75% and 95% of bitumen with a particle size less than 2 μm. Concentrated emulsions made according to these methods by phase inversion under laminar flow conditions, have a pasty behavior resembling mayonnaise, characterized by strong apparent viscosity, as this is described for example in the article of G. A. Nuñez, M. Briceño, C. Mata, H. Rivas and D. D. Joseph, “Flow Characteristics of Concentrated Emulsions of Very Viscous Oil in Water”, in the Journal of Rheology (Vol. 40, No. 3, 1996, pp. 405-423).

A means for reducing the viscosity of such emulsions, consists of diluting them with an aqueous solution which does not contain bitumen, thereby reducing the bitumen content and so losing the benefit of strong bitumen contents. This dilution method is described in the patents already mentioned, as well as in patent EP 0 994 923 belonging to Colas which consists of diluting a concentrated emulsion made continuously in a colloidal mill.

In other words, the existing methods for making concentrated bitumen emulsions generate too viscous emulsions for them to be used as such in road engineering and they are therefore diluted in order to be used at lower bitumen contents, losing the benefit of the strong bitumen concentration. The concentrated emulsion is therefore an intermediate making product.

However, it is known that the viscosity of an emulsion, in particular of bitumen, may be reduced without changing the bitumen content, by acting on the presence of several populations of drops with different sizes.

Thus, patent GB 362 577 belonging to Colas Products Limited, A. G. Terry, L. G. Gabriel and J. F. T. Blott, describes the making by a batch method of concentrated bitumen emulsions with up to 85% of bitumen, obtained by emulsifying in a reactor as coarse droplets, for example with a diameter of 20-30 μm, a bitumen within an already formed primary bitumen emulsion, the drop diameter of which is smaller and has a value of about 2 μm. This method however has the serious drawback of being discontinuous, which requires the building of a very large size reactor if the intention is to obtain fabrication yields of the order of 20 tons per hour which are the usual values in the trade. Further, it requires gradual addition of hot bitumen (125° C.) in a primary emulsion containing water, which generates strong steam emissions and significant overpressures requiring specific installations, very demanding in terms of safety. Also, vaporization of a portion of the water makes control of the contents of each of the constituents more difficult. Finally, this method generates a population of very coarse particles (20 μm-30 μm), which prove to be very unstable when stored and generate strong sedimentation of the emulsion.

U.S. Pat. No. 5,419,852 belonging to Intevep, S. A., describes the fabrication by a continuous method, of concentrated bitumen emulsions with low viscosity, having from 70%-85% of bitumen, obtained by mixing two primary emulsions characterized in that each emulsion has a different diameter, one having a diameter D_{L} of 10 μm-40 μm, and the other a diameter D_{S} less than 5 μm, and such that D_{L}/D_{S} is larger than 4 and that the mass proportion of drops with diameter D_{L} is comprised between 45% and 85%. However, this method has the drawback of requiring separated fabrication of two primary concentrated emulsions with strong viscosity which then have to be transported in order to be able to mix them. Even if the transport and mixing may be carried out on a same industrial installation, the pumping systems required for moving the primary emulsions involve major changes in present installations, such as strong pressure pumping systems, requiring specific installations very demanding in terms of safety.

The object of the present invention is to solve these problems by making a concentrated bitumen emulsion which may be produced without any difficulty with the means presently used for making roadway bitumen emulsion and having good storage stability.

Indeed and surprisingly, the Applicant discovered that by using a primary bitumen emulsion, characterized in that its particle size is less than 2 μm, in the aqueous phase used for making a secondary bitumen emulsion, characterized in that its particle size is larger than 2 μm, it is possible to obtain a final bitumen emulsion containing up to 95% of bitumen, characterized by an STV viscosity of 40° C. with the 4 mm orifice, of less than 300 seconds and a settling tendency as measured by the EN 12847 test, of less than 10%, so that it may be used with present methods for applying, storing and transporting roadway bitumen emulsions. This final emulsion may also be diluted in order to adjust its bitumen content.

According to a preferential embodiment of the invention, the primary emulsion content is such that the bitumen derived from the primary emulsion has a content between 5% and 95% by mass of the total bitumen, and preferentially between 10% and 40%.

According to a preferential embodiment of the invention, the median diameter of the primary emulsion is comprised between 0.2 μm and 2 μm excluded and preferentially comprised between 0.5 μm and 1.5 μm.

According to a preferential embodiment of the invention, the median diameter of the secondary emulsion is comprised between 2 μm excluded and 20 μm and preferentially comprised between 3 μm and 12 μm.

According to a preferential embodiment of the invention, the median diameter of the primary emulsion is at least twice smaller than that of the secondary emulsion, and preferentially at least three times smaller.

Each of these either primary or secondary emulsions may be made according to any suitable either continuous or discontinuous method notably in a colloidal mill, in one or a succession of static mixers, by phase inversion, . . . . Different methods may be used for each emulsion. According to a preferential embodiment of the invention, the secondary emulsion is made by a continuous method, for example in a colloidal mill or in one or a succession of static mixers. According to a still more preferential embodiment of the invention, the primary emulsion is made by phase inversion under laminar flow conditions as described in patent EP 0 999 890 and the secondary emulsion is made in a colloidal mill.

The primary emulsion may also be made by the method according to the invention, so as to use a final emulsion according to the invention as a primary emulsion of a novel emulsion according to the invention.

The primary emulsion may be diluted beforehand, optionally with an aqueous solution containing additives such as, and in a non-limiting way, emulsifiers, acids, bases, salts, thickeners, . . . . The dilution may also be performed during the making of the secondary emulsion, for example by directly injecting the primary emulsion, an aqueous dilution solution and the bitumen of the secondary emulsion within an emulsifying device.

The invention also relates to bitumen emulsions obtained in this way, the properties of which may easily be adjusted by wise selection of constituents.

According to an embodiment of the invention, the primary emulsion is made either with a bitumen different from that of the secondary emulsion, or with one or more different emulsifiers or a combination of both. The bitumens may notably differ by their grade and/or their origin and/or by the presence of one or more additives with which their properties may be adjusted, such as one or more polymers, an acid, a plasticizer, either alone or combined.

The primary emulsion may be made from a softer bitumen than the secondary bitumen, by selecting a suitable grade and/or by using a plasticizer, and/or a fluxing agent, so as to adjust handiness and/or compactibility and/or coating quality and/or mechanical properties of a cold mix using the composition.

The primary emulsion may also be made from a harder bitumen than the secondary bitumen, by selecting a suitable grade and/or by using a plasticizer and/or a fluxing agent, so as to adjust handiness and/or compactibility and/or coating quality and/or mechanical properties of a cold mix using the composition.

According to a preferential embodiment of the invention, the composition is characterized in that the bitumen of the primary emulsion is a polymer-modified bitumen, obtained by adding 0.5%-30% by weight of a polymer derived from the family of synthetic or natural elastomers, and more preferentially an elastomer selected from styrene and butadiene copolymers optionally cross-linked in situ or copolymers of ethylene and vinyl acetate and/or methyl acrylate as well as mixtures thereof.

The emulsifier of each emulsion may be selected from cationic, anionic, amphoteric, non-ionic emulsifiers or mixtures thereof. The primary and secondary emulsions may be made with different emulsifiers, with which the breakage kinetics of the emulsion may be adjusted. In particular, they may be selected in order to adjust handiness and/or compactibility, and/or coating quality of a cold mix using the composition. The emulsifier of the primary emulsion may also be used for emulsifying the secondary bitumen, without adding any addition emulsifier.

The primary emulsion may thus be made from a softer bitumen but also from a more stable emulsifier than for the secondary emulsion, with which when it is used in a cold mix, a “reserve” of non-broken soft fine emulsion may be kept for lubricating the bituminous mixture when it is in particular applied to compacting, and also allowing a more homogenous mixture to be produced.

The primary emulsion may also be made from harder bitumen but also from a more stable emulsifier than for the secondary emulsion, with which when it is used in a cold mix, it is possible to keep a non-broken hard fine emulsion “reserve” with which improved mechanical properties may be obtained in the long term (several weeks).

The primary emulsion may be made from a harder bitumen but also from an emulsifier less stable than from the secondary emulsion, with which, when it is used in a cold mix, it is possible to obtain a first broken hard fine emulsion film around granulates, with which improved mechanical properties may be obtained in the short term (a few hours).

The primary emulsion may be made from a bitumen modified by one or more polymers and the secondary emulsion may be made from pure bitumen, the selection of each of the emulsifiers being achieved so as to obtain during the breaking, a modified bitumen continuous phase within which are trapped bitumen drops of the secondary emulsion, in order to create an elastomeric “framework” within the binder film.

The primary emulsion and the aqueous phase of the secondary emulsion may further contain any type of additive with which the properties thereof may be controlled, among which viscosifying agents, setting regulators or salts, for example calcium, potassium, sodium chlorides or any other calcium, potassium, sodium or magnesium salt. The case when the additive is a non-bituminous emulsion, in particular a polymeric emulsion, for example synthetic rubber latex, is also considered.

According to a preferential embodiment of the invention, the content and nature of the polymer in the residual binder obtained after departure of water from the composition, provides resistance to fuels, notably to kerosene and gasolines, for example allowing their use in airport parking areas or fuel gasoline stations.

The invention also relates to the use of these compositions in particular in roadway or airport engineering, for making materials for new roadways, for reinforcing or maintaining old roadways, or their selective repair, but also for sealing work intended for roofs, bridges, etc. or further for paintwork, for example, and in a non-limiting way, of industrial floors.

According to a preferential embodiment of the invention, the composition enters the formulation of a concentrated tack layer with rapid breakage, in particular a so-called “clean” tack layer, the residual binder of which does not adhere to the tyres of on-site vehicles, by the use of hard bitumen.

According to a preferential embodiment of the invention, the composition enters the formulation of an impregnation emulsion, characterized in that the small particles from the primary emulsion penetrate into the granular support whereas the large particles remain at the surface forming a protective layer (curing or seal coating).

According to a preferential embodiment of the invention, the composition enters the formulation of a bituminous mix, for example a cold-cast mix, characterized by a resistance to fuels and/or by its large adherence by the entire or partial use of the granulates having a good polishing resistance coefficient, such as calcinated bauxite and/or by its non-black color by the use of transparent binders optionally combined with pigments and/or granulates selected for their color.

According to a preferential embodiment of the invention, the composition enters the formulation of a bituminous mix, for example a cold bituminous concrete, the mechanical properties of which during the application and/or final properties, once the emulsion is broken, are controlled by the use in the primary and secondary emulsions of different emulsifiers and/or of bitumens of different grades and/or containing plasticizers or fluxing agents of different nature and content.

According to a preferential embodiment of the invention, the composition enters the formulation of a surface dressing based on a concentrated emulsion with rapid breaking, which may be optionally characterized by its resistance to fuels, and/or its great adherence by the entire or partial use of the granulates having a good polishing resistance coefficient, such as calcinated bauxite and/or by its non-black color by the use of transparent binders optionally combined with pigments and/or granulates selected for their color.

The emulsion may also be used wherever concentrated bitumen emulsions are of interest, in particular in the making of mixes sometimes called semi-warm mixes, consisting of slightly preheated (less than 100° C.) granulates before kneading them in the presence of a concentrated bitumen emulsion.

The advantage and the practical embodiments of the invention are illustrated in a non-limiting way by the following examples.

### COMPARATIVE EXAMPLE 1

### Preparation of a Primary Emulsion EP0 According to the Prior Art

A primary emulsion EP0 containing 62% of Repsol 160/220 bitumen and 0.3% of fatty diamine emulsifier Asfier 100 from Kao, obtained industrially by means of a colloidal mill in the Probisa factory of Santiago de Compostela in Spain and with an average particle size of 4.18 microns is used.

### EXAMPLE 2

### Preparation of a Primary Emulsion EP1 According to the Invention

A primary emulsion EP1 (Table 1) is made by phase inversion under laminar flow conditions from a Nynas bitumen of grade 70/100 and from an aqueous phase acidified with hydrochloric acid in a sufficient amount in order to obtain one with a pH of 2.5 and containing 15% of cationic emulsifier, a fatty diamine (Dinoram S from Ceca).

10 parts by mass of the aqueous phase, initially at 50° C., are introduced into 100 bitumen parts at 90° C. placed in a heating reactor having a stirring system with controllable speed. Stirring is maintained at 600 rpm for about 15 minutes, and the thereby obtained concentrated emulsion is diluted to a bitumen mass content of 57%.

The median diameter of the corresponding EP1 emulsion, as measured by a laser granulometer Mastersizer 2000 of the Malvern brand, is 0.5 microns.

### EXAMPLE 3

### Preparation of a Primary Emulsion EP2 According to the Invention

A primary emulsion EP2 (Table 1) is made in the colloidal mill from a Nynas bitumen of grade 70/100 and from an aqueous phase containing 2% of a fatty acid amidoalkylbetaine (AGAAB) emulsifier provided by Goldschmidt, and a sufficient amount of caustic soda in order to obtain a pH of 12.5.

40 parts by mass of the aqueous phase, initially at 25° C., are introduced into 60 parts of bitumen at 140° C. within a laboratory colloidal mill Emulbitume.

The median diameter of the corresponding EP2 emulsion, as measured on the laser granulometer Mastersizer 2000, is 0.8 microns.

### EXAMPLE 4

### Preparation of a Primary Emulsion EP3 According to the Invention

A primary emulsion EP3 (Table 1) is made by phase inversion under laminar flow conditions from an industrial modified bitumen Styrelf 24/60, made by Eurovia in the Périgueux factory, containing 5% of in situ cross-linked styrene-butadiene block copolymer and an aqueous phase acidified with hydrochloric acid in a sufficient amount in order to obtain a pH of 2.5, and containing 20% of a cationic emulsifier, a fatty diamine (Dinoram S from Ceca).

10 parts by mass of the aqueous phase, initially at 50° C., are introduced into 100 parts of bitumen at 90° C., placed in a heating reactor having a stirring system with controllable speed. Stirring is maintained at 600 rpm for about 15 min and the thereby obtained concentrated emulsion is diluted to a final bitumen mass content of 61%.

The median diameter of the corresponding EP3 emulsion, as measured on the laser granulometer Mastersizer 2000, is 0.7 microns.

### COMPARATIVE EXAMPLE 5

### Preparation of a Final Emulsion EF0 According to the Prior Art

25 parts by mass of the primary emulsion EP0 are added to 75 parts of a Nynas 160/220 bitumen initially at 90° C. in a heating reactor having a stirring system with controllable speed. The stirring is maintained close to 200 rpm for about 3 min and the thereby obtained concentrated emulsion is diluted with 20 parts of water in order to obtain a rated final bitumen mass content of 75%.

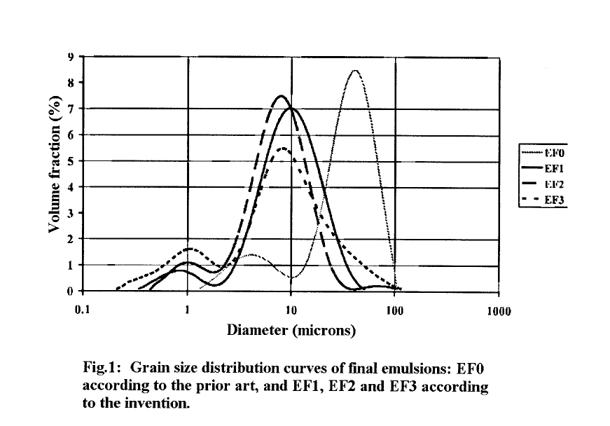

The corresponding EF0 emulsion (Table 2) has a clearly bimodal grain size distribution (FIG. 1). Its measured bitumen content is 73%, 17% of the total of which is present as a primary emulsion, by formulation. By fabrication, the emulsifier used in the primary emulsion (fatty diamine) is also the one used in the secondary emulsion. The STV viscosity at 40° C. through the 4 mm orifice, of the EF0 emulsion is 14 s and the settling tendency (long term stability) is 18% (Table 3).

### EXAMPLE 6

### Preparation of a Final Emulsion EF1 According to the Invention

0.25 parts by mass of a cationic emulsifier, a fatty polyamide (Polyram S from Ceca), are mixed with 16.75 parts of water acidified with hydrochloric acid in a sufficient amount in order to obtain a final pH of 2.5. 15 parts of the primary emulsion EP1 are mixed with this preparation in order to make up 32 parts of the aqueous phase of the secondary emulsion.

The 32 parts by mass of this aqueous phase, initially at 25° C., are introduced into 68 parts of Nynas 70/100 bitumen at 140° C. within the colloidal mill Emulbitume.

The corresponding EF1 emulsion (Table 2) has a clearly bimodal grain size distribution (FIG. 1). Its bitumen content is 77%, 11% of the total of which is present as a primary emulsion, by formulation. By fabrication, the emulsifier used in the primary emulsion (fatty diamine) is different from the one used in the secondary emulsion (fatty polyamine). The STV viscosity at 40° C. through the 4 mm orifice, of the emulsion EF1 is 38 s and the settling tendency (long term stability) is 2% (Table 3).

### EXAMPLE 7

### Preparation of a Final Emulsion EF2 According to the Invention

2 parts by mass of the AGAAB emulsifier already used for the EP2 emulsion are mixed with 16 parts of basified water by adding caustic soda in a sufficient amount in order to obtain a final pH of 12.5. 15 parts of the primary emulsion EP2 are mixed with this preparation in order to make up 33 parts of aqueous phase of the secondary emulsion.

The 33 parts by mass of this aqueous phase, initially at 25° C., are introduced into 67 parts of a BP 80/100 bitumen at 140° C. within the colloidal mill Emulbitume.

The corresponding EF2 emulsion (Table 2) has a clearly bimodal grain size distribution (FIG. 1). Its bitumen content is 76%, 12% of the total of which is present as a primary emulsion by formulation. The STV viscosity at 40° C. through the 4 mm orifice, of the EF2 emulsion is 26 s and the settling tendency (long term stability) is 3% (Table 3).

### EXAMPLE 8

### Preparation of a Final EF3 Emulsion According to the Invention

5 parts of water acidified with hydrochloric acid in a sufficient amount for obtaining a final pH of 2.5 are added to 25 parts of the primary emulsion EP3 in order to make up 30 parts of aqueous phase of the secondary emulsion.

The 30 parts by mass of this aqueous phase, initially at 25° C., are introduced into 70 parts of Total 160/220 bitumen at 140° C. within the colloidal mill Emulbitume.

The corresponding EF3 emulsion (Table 2) has a clearly bimodal grain size distribution (FIG. 1). Its bitumen content is 85%, 18% of the total of which is present as a primary emulsion, by formulation. By fabrication, the bitumen used in the primary emulsion is modified by a polymer whereas the one used in the secondary emulsion is not modified. Further, their grades are different. The STV viscosity at 40° C. through the 4 mm orifice, of the emulsion EF3 is 180 s and the settling tendency (long term stability) is 1% (Table 3).

TABLE 1
Composition of the primary emulsion (the
mass percentages are given relatively to the emulsion).

| | | EP0 | EP1 | EP2 | EP3 |
|---|---|---|---|---|---|
| | | According to | According | According | According |
| | | the prior | to the | to the | to the |
| | | art | invention | invention | invention |
| Method | | Colloidal | IPRL | Colloidal | IPRL |
| | | mill | | mill | |
| Bitumen | Nature | Repsol | Nynas | Nynas | Styrelf |
| | | 160/220 | 70/100 | 70/100 | 24/60 |
| Bitumen | % | 62 | 57 | 60 | 61 |
| Emulsifier | Nature | Diamine | Diamine | AGAAB | Diamine |
| Emulsifier | % | 0.3 | 0.9 | 2.0 | 1.2 |
| pH | — | 2.5 | 2.5 | 12.5 | 2.5 |

TABLE 2
Composition of the final emulsions
according to the invention (the mass percentages are
given relatively to the final emulsion).

| | | EF0 | EF1 | EF2 | EF3 |
|---|---|---|---|---|---|
| | | According | According | According | According |
| | | to the | to the | to the | to the |
| | | prior art | invention | invention | invention |
| Method | | IPRL | Colloidal | Colloidal | Colloidal |
| | | | mill | mill | mill |
| Primary | Nature | EP0 | EP1 | EP2 | EP3 |
| emulsion | | | | | |
| Content | % | 25 | 15 | 15 | 25 |
| Secondary | Nature | — | Polyamine | AGAAB | — |
| emulsifier | | | | | |
| Content | % | — | 0.25 | 2 | — |
| Water | % | 20 | 16.75 | 16 | 5 |
| balance | | | | | |
| pH | — | 2.5 | 2.5 | 12.5 | 2.5 |
| i.e. | % | 37.5 | 32 | 33 | 30 |
| aqueous | | | | | |
| phase | | | | | |
| Secondary | Nature | Nynas | Nynas | BP 80/100 | Total |
| bitumen | | 160/220 | 70/100 | | 160/220 |
| Secondary | % | 62.5 | 68 | 67 | 70 |
| bitumen | | | | | |

TABLE 3
Properties of the final emulsions
according to the invention.

| | | EF0 | EF1 | EF2 | EF3 |
|---|---|---|---|---|---|
| | | According | According | According | According |
| | | to the | to the | to the | to the |
| | | prior art | invention | invention | invention |
| Total | % | 73 | 77 | 76 | 85 |
| bitumen | | | | | |
| Including | % | 17 | 12 | 11 | 18 |
| primary | | | | | |
| bitumen | | | | | |
| Primary d₅₀ | Microns | 4.2 | 0.5 | 0.8 | 0.7 |
| Secondary d₅₀ | Microns | 40.2 | 9.3 | 8.2 | 8.0 |
| Secondary | — | 10 | 19 | 10 | 11 |
| d₅₀/primary | | | | | |
| d₅₀ | | | | | |
| STV | S | 14 | 38 | 26 | 180 |
| viscosity | | | | | |
| 4 mm, 40° C. | | | | | |
| Long term | % | 18 | 2 | 3 | 1 |
| stability | | | | | |

1. A method for making a bituminous emulsion comprising combining a primary bitumen emulsion, characterized by a median diameter smaller than 2 μm, and a secondary bitumen emulsion, characterized by a median diameter larger than 2 μm, to obtain a final emulsion having a bitumen content from 50% to 95% by mass, an STV viscosity at 40° C. through the 4 mm orifice, less than 300 s and a settling tendency as measured by the EN 12847 test, less than 10%.

2. The method according to claim 1, characterized in that the ratio of the median diameter of the secondary emulsion to the median diameter of the primary emulsion is larger than 2.

3. The method according to claim 1, characterized in that the median diameter of the primary emulsion is between 0.2 μm and 2 μm excluded.

4. The method according to claim 1, characterized in that the median diameter of the secondary emulsion is between 2 μm excluded and 20 μm.

5. The method according to claim 1, characterized in that the bitumen content from the primary emulsion is between 5% and 95% of the total bitumen.

6. The method according to claim 1, characterized in that the primary bitumen emulsion is obtained by phase inversion under laminar flow conditions and the secondary bitumen emulsion is obtained by a colloidal mill.

7. The method according to claim 1, characterized in that the bitumen used in the primary bitumen emulsion differs by the grade, the origin and/or the presence of additives from the bitumen used in the secondary bitumen emulsion.

8. The method according to claim 1, characterized in that the bitumen of the primary bitumen emulsion is a bitumen modified by a polymer and the bitumen of the secondary bitumen emulsion does not contain any polymer.

9. The method according to claim 8, characterized in that the bitumen modified by a polymer of the primary bitumen emulsion is obtained by adding from 0.5% to 30% relative to the bitumen of elastomers selected from optionally cross-linked in situ, styrene and butadiene block or random copolymers, copolymers of ethylene and vinyl acetate, copolymers of methyl or butyl acrylate, and mixtures thereof.

10. The method according to claim 1, characterized in that the emulsifier(s) used for making the primary emulsion is (are) used without any additional provision of emulsifier for making the secondary emulsion.

11. The method according to claim 1, characterized in that the emulsifier(s) used for making the primary emulsion is (are) different from the one (or those) used for making the secondary emulsion.

12. An aqueous bituminous composition obtained by a method according to claim 1.

13. A method for roadway engineering or in sealing, comprising applying to a surface the composition of claim 12.

14. A method for making surface coatings, cold mixes, tack or impregnation layers, comprising formulating the composition of claim 12.

15. A bituminous mix comprising a composition according to claim 12.

16. The method according to claim 2, characterized in that the ratio of the median diameter of the secondary emulsion to the median diameter of the primary emulsion is larger than 3.

17. The method according to claim 3, characterized in that the median diameter of the primary emulsion is between 0.5 μm and 1.5 μm.

18. The method according to claim 4, characterized in that the median diameter of the secondary emulsion is between 3 μm and 12 μm.

19. The method according to claim 5, characterized in that in that the bitumen content from the primary emulsion is between 10% and 40% of the total bitumen.
